(19) United States
(12) Patent Application Publication
(10) Pub. No.: US 2025/0362392 A1
(43) Pub. Date: Nov. 27, 2025

(54) PHOTOELECTRIC SENSOR SYSTEM, RECEIVING CHIP, AND LIDAR

(71) Applicant: SUTENG INNOVATION TECHNOLOGY CO., LTD., Shenzhen (CN)

(72) Inventor: Jianrong LIANG, Shenzhen (CN)

(73) Assignee: SUTENG INNOVATION TECHNOLOGY CO., LTD., Shenzhen (CN)

(21) Appl. No.: 19/214,009

(22) Filed: May 20, 2025

(30) Foreign Application Priority Data
May 22, 2024 (CN) 202410642391.0

(51) Int. Cl. G01S 7/4861; G01S 7/484; G01S 7/487

(52) U.S. Cl. CPC G01S 7/4861; G01S 7/484; G01S 7/4873

(57) ABSTRACT

A photoelectric sensor system, a receiving chip, and a LiDAR are provided. The photoelectric sensor system includes a planar array photoelectric sensor and a control circuit. The planar array photoelectric sensor includes at least two array-arranged photoelectric sensor groups, and the common anodes of the photoelectric sensor groups in each row or each column are connected. The first end of the control circuit is connected with the common anodes of the photoelectric sensor groups in each row or each column, and the second end of the control circuit is connected with the cathodes of each photoelectric sensor group. The control circuit is used for conducting the common anodes and the cathodes of a portion of the photoelectric sensor groups to obtain digital signals corresponding to a portion of echo signals.

### CROSS-REFERENCE TO RELATED APPLICATION

The present application claims the benefit of priority to Chinese Patent Application No. 202410642391.0, filed on May 22, 2024, which is hereby incorporated by reference in its entirety.

### TECHNICAL FIELD

The present application relates to the technical field of LiDAR, and in particular to a photoelectric sensor system, a receiving chip and a LiDAR.

### BACKGROUND

In a LiDAR, a photoelectric sensor system is used for receiving echo signals and obtaining corresponding distance information. At present, in the related art, all the photoelectric sensor units in the photoelectric sensor system need to be activated to read all the received echo signals and process the signals. However, in this way, the hardware cost is high, and the devices can be overheated, leading to performance attenuation and affecting their use. When the LiDAR detects a high-reflectivity object, point cloud expansion occurs, because the energy reflected by the high-reflectivity object is more than 100 times the energy reflected by a normal-reflectivity object, resulting in diffusion or expansion of the point cloud data when generated, thereby affecting the object recognition capability of the LiDAR.

### SUMMARY

Embodiments of the present application provide a photoelectric sensor system, a receiving chip, and a LiDAR. The photoelectric sensor system can selectively conduct the common anode and the cathode of the photoelectric sensor group, and acquire the corresponding echo signal for processing. In this way, the processing load of the photoelectric sensor system is reduced, the working stability of the photoelectric sensor system is ensured, and the detection accuracy is improved.

In a first aspect, the embodiment of the present application provides an photoelectric sensor system applied to a LiDAR, the photoelectric sensor system including: an array photoelectric sensor including at least two arrayed photoelectric sensor groups, and a plurality of the photoelectric sensor groups in each row or each column are connected in common anode; and a control circuit, a first end of the control circuit being connected with the common anodes of the plurality of photoelectric sensor groups in each row or each column, and a second end of the control circuit being connected with the cathodes of the photoelectric sensor groups, the control circuit being configured to turn on the common anodes and the cathodes of part of the photoelectric sensor groups to obtain digital signals corresponding to part of echo signals.

In the technical solution, the control circuit can only turn on and read the echo signal in the light spot area, and does not turn on the cathodes of the photoelectric sensor groups in the non-light spot area, that is, does not read the echo signal in the non-light spot area. Thus, the control circuit can selectively read the echo signal received by the array photoelectric sensor, so as to filter out the effective echo signal in the array photoelectric sensor and read the effective echo signal while completing the LiDAR ranging function, without reading invalid echo signals in the non-light spot area, thereby reducing the processing burden of the control circuit, avoiding data processing circuit overload that may affect performance, ensuring stable operation of the photoelectric sensor system, and significantly enhancing system adaptability and performance by dynamically adjusting the number and positions of activated receiving devices, ultimately improving detection accuracy and reliability.

In an implementation form of the first aspect, the photoelectric sensor group includes at least one photoelectric sensor.

In the technical solution, each photoelectric sensor is an independent individual, so that the control circuit can selectively conduct and read the echo signal from a single sub-photoelectric sensor.

In an implementation form of the first aspect, the photoelectric sensor group includes three photoelectric sensors, and the three photoelectric sensors are arranged in parallel sequentially.

In the technical solution, the control circuit selectively turns on and reads the echo signal from the photoelectric sensor group composed of the three photoelectric sensors, thereby avoiding the problem where a single photoelectric sensor may not fully receive the echo light spot, which could result in the loss of certain features of the echo light spot and negatively impact the completeness of light reception. By configuring the three photoelectric sensors as a photoelectric sensor group corresponding to a single echo light spot, the system ensures more complete and reliable reception of the light spot by the planar array photoelectric sensor.

In an implementation form of the first aspect, the control circuit includes: a logic unit; and a first switch unit including a plurality of first switches, where the plurality of first switches are respectively connected with the common anodes of the plurality of photoelectric sensor groups in one-to-one correspondence, and controlled ends of the plurality of first switches are all connected with the logic unit; where the logic unit is configured to control the on-off states of the plurality of first switches to control the common anodes of the plurality of photoelectric sensor groups.

In an implementation form of the first aspect, the control circuit further includes: an amplification unit including a plurality of amplifiers, wherein first ends of the plurality of amplifiers are respectively connected with the cathodes of the plurality of photoelectric sensor groups, and the amplification unit is configured to amplify the echo signals received by the photoelectric sensor groups; and a second switch unit including a plurality of second switches, where one ends of the plurality of second switches are respectively connected with second ends of the plurality of amplifiers, and controlled ends of the plurality of second switches are all connected with the logic unit; wherein the logic unit is further configured to control the on-off states of the plurality of second switches to control the amplifiers.

In an implementation form of the first aspect, the control circuit further includes: an analog switch unit, one end of the analog switch unit being connected with third ends of the plurality of amplifiers, and the analog switch unit being configured to obtain the amplified echo signals when part of the second switches is turned on by the logic unit.

In an implementation form of the first aspect, the control circuit further includes: a comparison unit, one end of the comparison unit being connected with the other end of the analog switch unit, and used for converting the echo signal into the digital signal.

In an implementation form of the first aspect, the control circuit further includes: a digital processing circuit, the other end of the comparison unit being connected with the digital processing circuit, and used for acquiring corresponding distance information according to the digital signal.

In a second aspect, a receiving chip, including the photoelectric sensor system, the photoelectric sensor system of any optional mode of the first aspect.

In a third aspect, embodiments of the application provide a LiDAR, including a transmitting module and the photoelectric sensor system in any optional manner of the first aspect; the transmitting module includes a plurality of array-arranged laser light sources, the laser light sources are used for emitting laser light, and the photoelectric sensor system is used for receiving a corresponding echo signal of the laser light and acquiring corresponding distance information.

In a fourth aspect, embodiments of the application provide a movable device, which includes a movable body and the LiDAR in any optional manner of the third aspect, and the LiDAR is carried on the body.

Based on the photoelectric sensor system, the control circuit can selectively read the echo signal received by the planar array photoelectric sensor, so as to filter out the effective echo signal from the planar array photoelectric sensor and read the effective echo signal while completing the LiDAR ranging function, without reading the invalid echo signal in the non-spot region. This reduces the processing burden of the control circuit, avoids data processing circuit overload that may affect the use, ensures the working stability of the photoelectric sensor system, and, through dynamic adjustment of the number and position of the turned-on receiving devices, improves the adaptability and performance of the photoelectric sensor system, thereby improving the detection accuracy and reliability.

### BRIEF DESCRIPTION OF DRA WINGS

In order to more clearly illustrate the embodiments of the present application or the technical solutions in the prior art, the drawings are briefly introduced below. Obviously, the drawings described below are only some embodiments of the present application. For ordinary technicians in this field, other drawings can be obtained based on these drawings without paying any creative work.

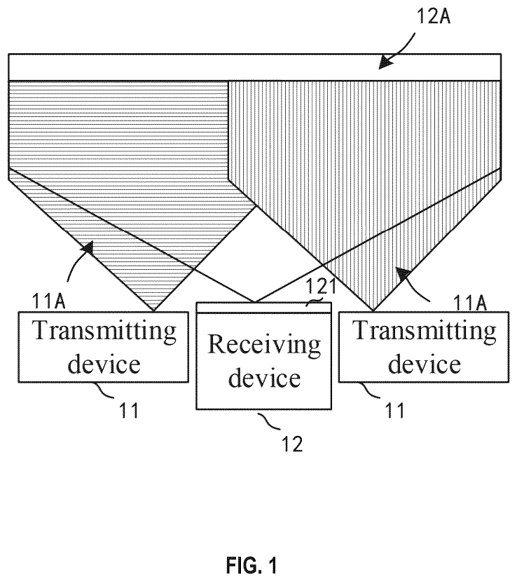

FIG. 1 is a schematic diagram of a structure of a LiDAR provided by the related art;

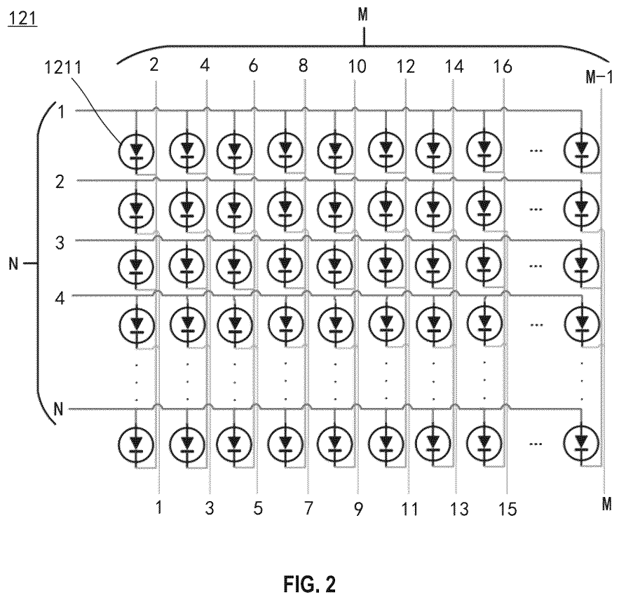

FIG. 2 is a schematic diagram of a circuit structure of a photoelectric sensor array provided by the related art;

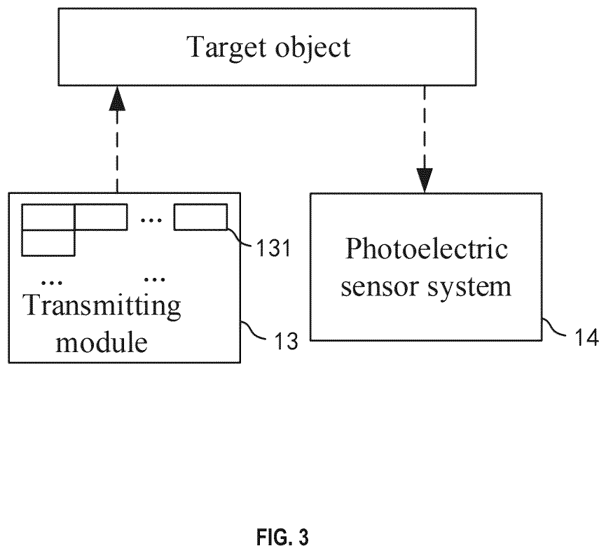

FIG. 3 is a schematic diagram of a module structure of a LiDAR provided by some embodiments of the present application;

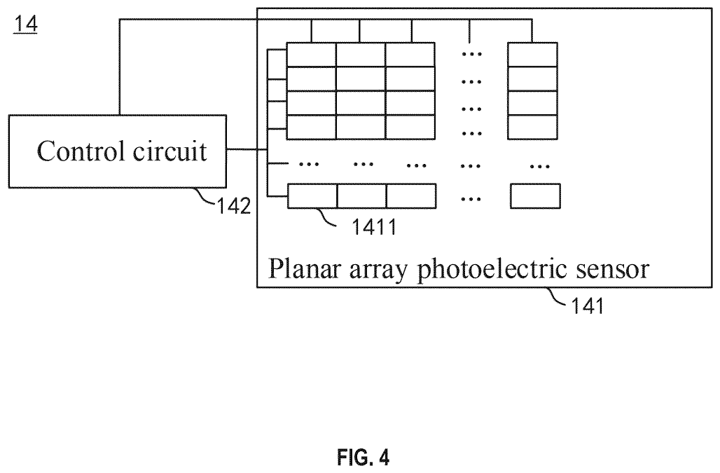

FIG. 4 is a schematic diagram of a module structure of a photoelectric sensor system provided by an embodiment of the present application;

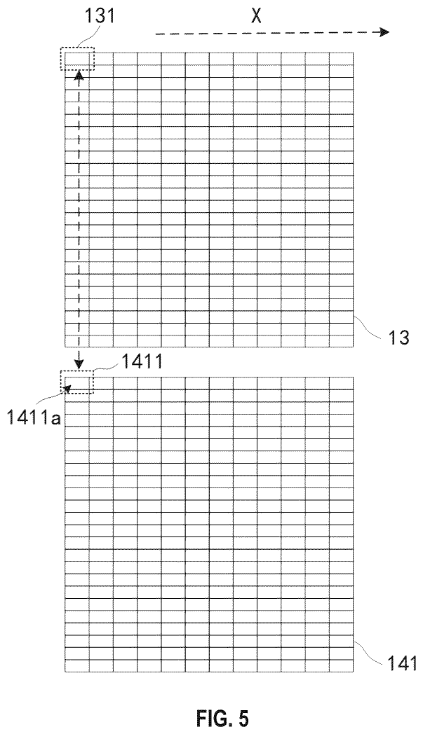

FIG. 5 is a schematic diagram of another module structure of a LiDAR provided by some embodiments of the present application;

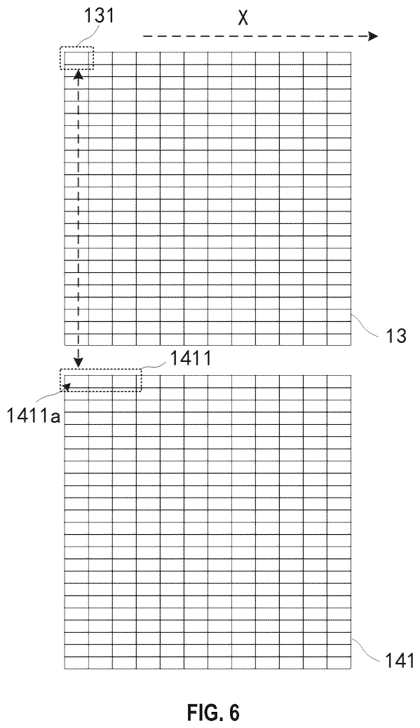

FIG. 6 is a schematic diagram of still another module structure of a LiDAR provided by some embodiments of the present application;

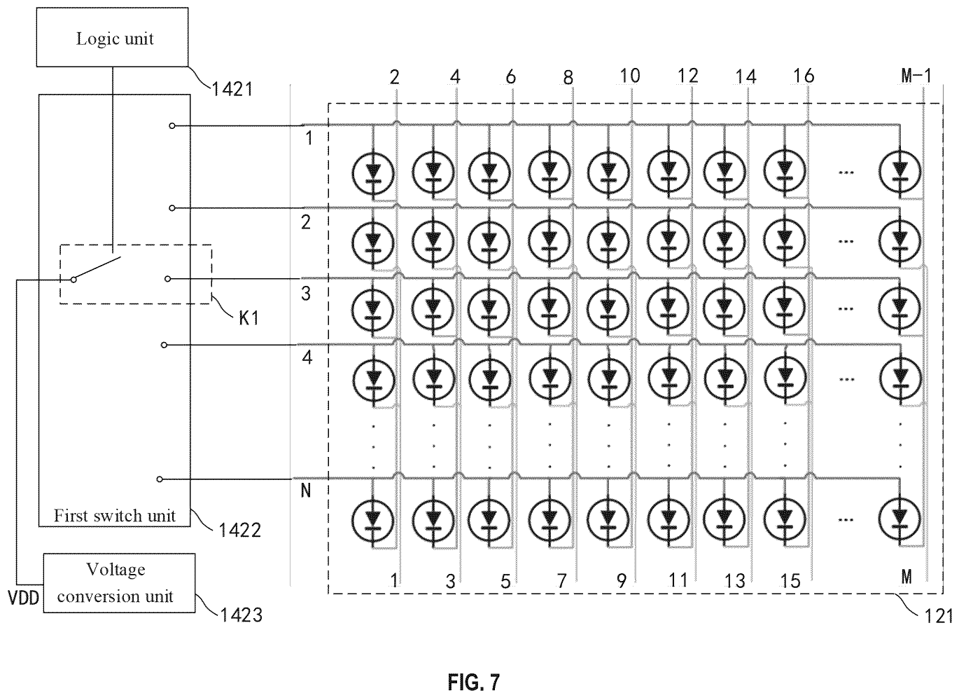

FIG. 7 is a schematic diagram of a process of a circuit structure of a LiDAR provided by some embodiments of the present application;

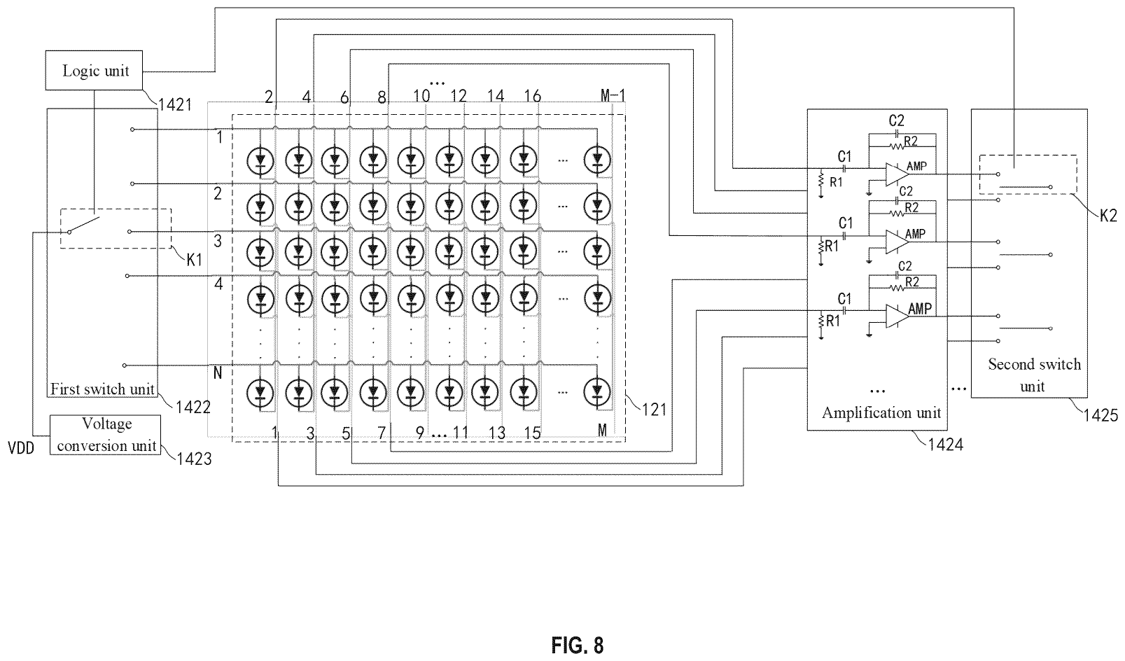

FIG. 8 is a schematic diagram of another circuit structure of a LiDAR provided by some embodiments of the present application;

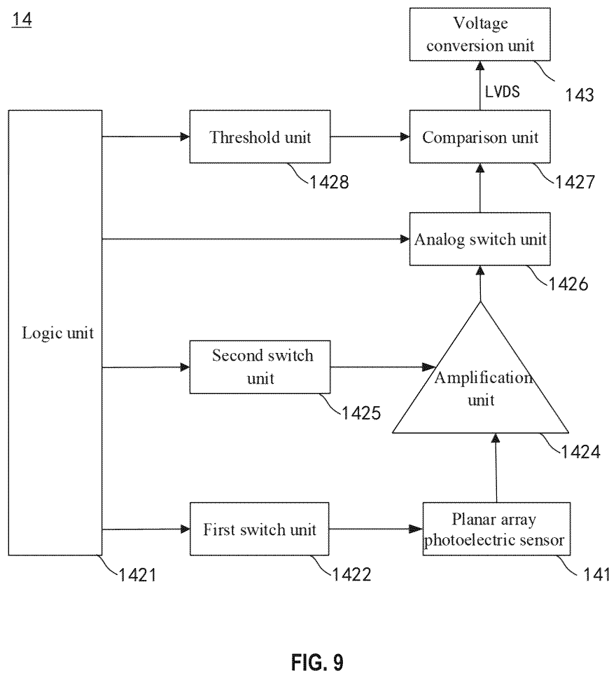

FIG. 9 is a schematic diagram of still another circuit structure of a LiDAR provided by some embodiments of the present application;

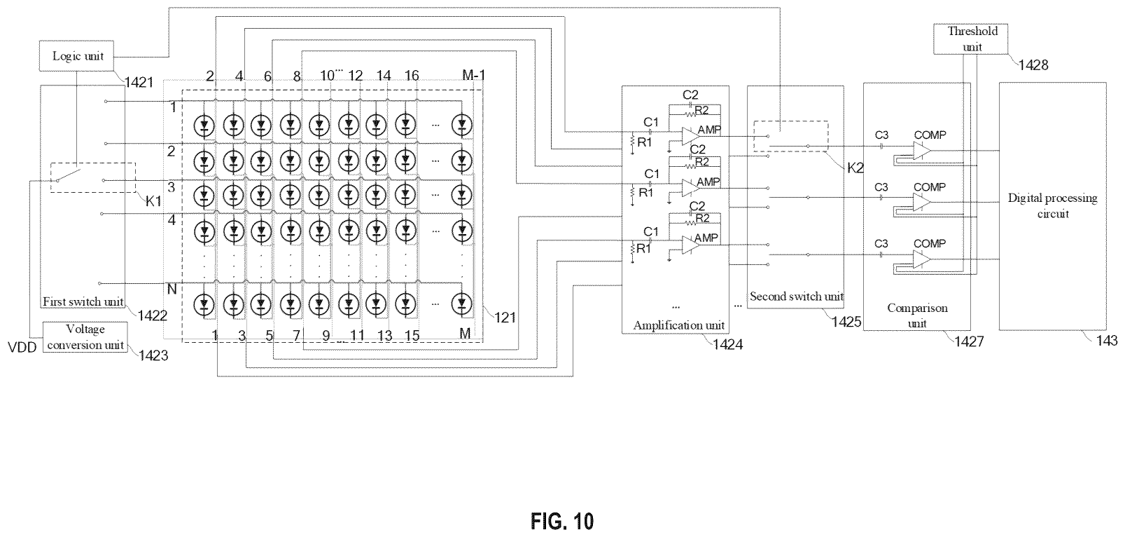

FIG. 10 is a schematic diagram of yet another circuit structure of a LiDAR provided by some embodiments of the present application.

### REFERENCE NUMERALS

1, LiDAR; 11, transmitting device; 11A, transmitting region; 12, receiving device; 12A, receiving region; 121, photoelectric sensor array; 1211, photoelectric sensor; 13, transmitting module; 131, laser light source; 14, photoelectric sensor system; 141, planar array photoelectric sensor; 1411, photoelectric sensor group; 1411a, photoelectric sensor; 142, control circuit; 1421, logic unit; 1422, first switch unit; 1423, voltage conversion unit; 1424, amplification unit; 1425, second switch unit; 1426, analog switch unit; 1427, comparison unit; 1428, threshold unit; 143, digital processing circuit; X, horizontal direction; K1, first switch; K2, second switch; VDD, power voltage; AMP, amplifier; R1, first resistor; R2, second resistor; C1, first capacitor; C2, second capacitor; C3, third capacitor; LVDS, digital signal; COMP, comparator.

### DETAILED DESCRIPTION

In order to make the purpose, technical scheme, and advantages of the present application clearer, the following description will further detail the embodiments of the present application with reference to the accompanying drawings.

In the description that follows, like parts are marked throughout the specification and drawings with the same reference numerals, respectively. The word “exemplary” is used herein to mean “serving as an example, instance, or illustration.” Any embodiment described herein as “exemplary” is not necessarily to be construed as being preferred or advantageous over other embodiments.

It should be understood that the term “and/or” used in the present application specification and the appended claims refers to any combination of one or more of the associated listed items and all possible combinations, and includes these combinations. In addition, in the description of the present application specification and the appended claims, the terms “first,” “second,” “third,” and the like are only used to distinguish the description, and cannot be understood as indicating or implying relative importance.

Unless otherwise defined, all technical and scientific terms used herein have the same meaning as commonly understood by one of ordinary skill in the art to which this application belongs. The terminology used in the description herein is for the purpose of describing particular embodiments only and is not intended to be limiting. As used herein, the term “and/or” includes any and all combinations of one or more of the associated listed items.

Before the embodiments of the present application are introduced, the professional terms that may be involved in the embodiments of the present application are explained below.

LiDAR: a radar system for detecting the position, velocity, and other characteristic quantities of a target by emitting a laser beam. Its working principle is that a detection signal (laser beam) is emitted to the target object, and then the received echo signal reflected by the target object is compared with the detection signal (or the local signal). After appropriate signal processing, the relevant information of the target object relative to the LiDAR, such as distance, direction, height, velocity, posture, even shape, etc., can be obtained.

There are usually a transmitting module and a receiving module in the LiDAR. The transmitting module is configured to emit a detection signal to the target object, and the receiving module is configured to receive the echo signal reflected by the target object and perform processing. As an example of the LiDAR shown in FIG. 1, which is a LiDAR employing a vertical-cavity surface-emitting laser (VSCEL), the LiDAR includes two transmitting devices 11 and one receiving device 12. The transmitting device 11 is provided with a laser light source that emits laser light through a light lens. The laser light covers the entire field of view (FOV), that is, the two transmitting areas (TX views) 11A shown in FIG. 1, and part of the areas of the two transmitting areas 11A overlap. When the laser light hits the target object, the laser light is reflected as an echo signal. At this time, the receiving device 12 is configured to receive the echo signal. The receiving device 12 is provided with a photoelectric sensor array 121. The photoelectric sensor array 121 receives the echo signal in the receiving area (RX view) 12A. The receiving device of the LiDAR 1 reads the echo signal and sends the echo signal to a digital processing unit. The digital processing unit obtains the detection information of the detected object by calculating the echo signal.

It can be understood that the photoelectric sensor array 121 is an example of the photoelectric sensor system. In this application, the specific arrangement of the photoelectric sensor array 121 and the number of photoelectric sensors included in the photoelectric sensor array 121 are not limited. In this application, the transmitting laser can be a vertical cavity surface-emitting laser or an edge-emitting laser (EEL), and this is not limited thereto. The photoelectric sensor array in this application can be a SPAD array.

The transmitting laser in the application can be a vertical cavity surface emitting laser or an edge-emitting laser (EEL), and the application does not make a unique limitation in this respect.

The photoelectric sensor array in the application can be a SPAD array or a SIPM, and each photoelectric sensor can be a SPAD.

It can be understood that the application does not specifically limit the number of transmitting devices and receiving devices, that is, one transmitting region can correspond to one receiving region, two transmitting devices can correspond to one receiving device, or two transmitting devices can correspond to two receiving devices. No limitation is imposed in this respect.

It can be understood that the LiDAR can further include a scanning device, where the scanning device can include a rotating mirror, a galvanometer, or a rotating platform, and no limitation is imposed thereto.

The photoelectric sensor array 121 with high integration degree is widely applied in the LiDAR 1 because it has high photoelectric conversion efficiency and small size and can meet the miniaturization and light weight development of the LiDAR 1. As shown in FIG. 2, the photoelectric sensor array 121 in the related art is usually composed of N rows*M columns of photoelectric sensors 1211, each photoelectric sensor 1211 outputs one cathode and one anode. The photoelectric sensors 1211 in each row of the N rows share the anode, and the photoelectric sensors 1211 in each column of the M columns are divided into two connection lines according to odd and even numbers and are respectively connected with a driving circuit. Exemplarily, assuming that the photoelectric sensor array 121 is composed of 6 rows*6 columns of photoelectric sensors 1211, the photoelectric sensors 1211 in each row of the 6 rows share the anode, the cathodes of the photoelectric sensors 1211 corresponding to the 1st row, the 3rd row and the 5th row in the 1st column are connected with the driving circuit through one line, and the cathodes of the photoelectric sensors 1211 corresponding to the 2nd row, the 4th row and the 6th row in the 1st column are connected with the driving circuit through another line. When the LiDAR 1 works, the driving circuit needs to turn on the anode of the corresponding photoelectric sensor 1211 to read out the echo signal of the cathode of the photoelectric sensor 1211.

In this way, by connecting the photoelectric sensors 1211 in each column of the M columns with the driving circuit through two connection lines according to odd and even numbers, the response speed of the receiving device is improved, and the circuit loss is reduced. Here, it is worth mentioning that the photoelectric sensor array 121 can be configured in groups, in some embodiments, the number of cathodes and/or anodes of the photoelectric sensor array 121 can be divided according to the size of the surface array of the photoelectric sensor array 121 to realize the grouping setting, and no specific limitation is imposed thereto.

Within the FOV, the photoelectric sensors 1211 on the photoelectric sensor array 121 can all receive the laser light of the VSCEL array. In the related art, the driving circuit is usually designed in two ways to correspond to the turn-on and reading of the anode and cathode of the photoelectric sensor 1211, one of which is to turn on the anodes of all photoelectric sensors 1211 in N rows*M columns, and read out the echo signals of the cathodes of all photoelectric sensors 1211, that is, all photoelectric sensors 1211 in the photoelectric sensor array 121 need to be in an activated state to read and process all received echo signals. However, in this way, the design cost is high, and the thermal performance of the photoelectric sensor array 121 and the driving circuit can be degraded, causing the digital processing unit to be overloaded and affecting use.

The other way is to partially turn on the anodes of all photoelectric sensors 1211 in a whole row or a whole column, and read out the echo signals of the cathodes of the photoelectric sensors 1211 in the whole row or the whole column, thereby reducing the design cost. However, when the target object detected by LiDAR1 is a high-reflection obstacle, that is, an object with a reflectivity greater than 300%, such as a circular object, the photoelectric signals in the same row or the same column can be saturated, thereby causing the whole row or the whole column to be crosstalked by the high-reflection feature. If LiDAR1 detects a low-reflection obstacle at this time, there can be a problem of misjudgment of the low-reflection obstacle by the same row or the same column, affecting the test effect.

The other way is to partially turn on the anodes of all photoelectric sensors 1211 in a whole row or a whole column, and read out the echo signals of the cathodes of the photoelectric sensors 1211 in the whole row or the whole column, thereby reducing the design cost. However, when the target object detected by LiDAR1 is a high-reflection obstacle, that is, an object with a reflectivity greater than 300%, such as a circular object, the photoelectric signals in the same row or the same column can be saturated, thereby causing the whole row or the whole column to be crosstalked by the high-reflection feature. If LiDAR1 detects a low-reflection obstacle at this time, there can be a problem of misjudgment of the low-reflection obstacle by the same row or the same column, affecting the test effect.

To this end, the photoelectric sensor system, the laser radar, and the movable device provided in the embodiments of the present application can selectively turn on the common anode and the cathode of the photoelectric sensor group, and acquire and process the corresponding echo signals, thereby reducing the processing burden of the photoelectric sensor system, ensuring the working stability of the photoelectric sensor system, reducing the optical crosstalk between adjacent sensors in a high-reflection state, and improving the detection accuracy.

The photoelectric sensor system, the LiDAR, and the movable device provided in the embodiments of the present application are described below in conjunction with the accompanying drawings.

As shown in FIG. 3, LiDAR1 provided in the embodiments of the present application includes a transmitting module 13 and a photoelectric sensor system 14. The transmitting module 13 includes a plurality of array-arranged laser light sources 131, the laser light sources 131 are used to emit laser to detect a target object, and the photoelectric sensor system 14 is used to receive and process echo signals reflected from the target object to obtain corresponding distance information.

In an example, as shown in FIG. 4, the photoelectric sensor system 14 can include a planar array photoelectric sensor 141 and a control circuit 142. The planar array photoelectric sensor 141 includes at least two array-arranged photoelectric sensor groups 1411, and a plurality of the photoelectric sensor groups in each row or each column are connected in common anode, the first end of the control circuit 142 is connected with the common anodes of the photoelectric sensor groups 1411 in each row or each column, and the second end of the control circuit 142 is connected with the cathodes of each photoelectric sensor group 1411. It is worth noting that the anodes of the photoelectric sensor groups 1411 can also be grouped, and the control circuit 142 can control the grouping of the anodes of the photoelectric sensor groups 1411 based on bias control, that is, different groups of anodes can be connected to different power supplies, so as to adjust the voltage values of different groups for control. For example, the control circuit 142 can control the anodes of part of the photoelectric sensor groups 1411 to be connected to a high level, and the anodes of part of the photoelectric sensor groups 1411 to be connected to a low level. In this way, the grouping of the anodes of the photoelectric sensor groups 1411 is realized based on bias control, and meanwhile, in order to improve the dynamic range of the planar array photoelectric sensor 141, multiple power supplies can be arranged for the groups corresponding to the central region of the planar array photoelectric sensor 141, so as to realize the purpose of adjustable bias of the central region. In this way, when the grouping of the anodes of the photoelectric sensor groups 1411 needs to be adjusted, the grouping region can be set based on bias control (for example, the transformation of high and low levels), and the setting and adjusting accuracy is high, so as to improve the detection accuracy and reliability of the system.

The control circuit 142 is configured to turn on the common anode and the cathode of part of the photoelectric sensor groups 1411 to obtain a digital signal corresponding to part of the echo signals. It should be noted that the part of the photoelectric sensor groups 1411 is a row or a column in the N rows*M columns.

For example, assuming that the planar array photoelectric sensor 141 is provided with 6 rows and 6 columns, the control circuit 142 can first turn on the common anode of the first row, i.e., the anodes of all photoelectric sensor groups 1411 in the first row, and then turn on the cathodes of some photoelectric sensor groups 1411 in the first row according to the movement of the echo light spot among the photoelectric sensor groups 1411 in the first row. For example, when the echo light spot moves among the photoelectric sensor groups 1411 in the first row, first column, second column, and fifth column, the control circuit 142 can turn on the cathodes of the photoelectric sensor groups 1411 in the first row, first column, second column, and fifth column to read the corresponding echo signals. In this way, the control circuit 142 can only turn on and read the echo signals in the light spot area (e.g., the area formed by the first column, second column, and fifth column in the first row), and does not turn on the cathodes of the photoelectric sensors 1411 in the non-light spot area (e.g., the area formed by the third column, fourth column, and sixth column in the first row), i.e., does not read the echo signals in the non-light spot area. In this way, the control circuit 142 can selectively read the echo signals received by the planar array photoelectric sensor 141 to complete the ranging function of LiDAR1. Meanwhile, the control circuit 142 filters out the valid echo signals in the planar array photoelectric sensor 141 for reading, and does not need to read the invalid echo signals in the non-light spot area, thereby reducing the processing amount of the control circuit 142, avoiding overload of the control circuit 142, and ensuring the working stability of the photoelectric sensor system 14.

In some embodiments, the control circuit 142 can cooperate with the emission light spot to turn on the common anode and the cathode of some photoelectric sensor groups 1411. In this way, the control circuit 142 can turn on the common anode and the cathode of the corresponding photoelectric sensor groups 1411 based on the emission light spot, and different emission light spots in different scenes can also turn on the corresponding photoelectric sensor groups 1411, thereby achieving dynamic adjustment of the positions and number of the photoelectric sensor groups 1411, improving the detection accuracy and reliability, and improving the accuracy and reliability of the entire photoelectric sensor system 14.

In some embodiments, the control circuit 142 can adjust the turned-on part of the common anode and the cathode of the photoelectric sensor groups 1411 according to the acquired detection distance information, i.e., the turned-on part of the common anode and the cathode of the photoelectric sensor groups 1411 can be adjusted according to the offset of the echo light spot at different distances. In this way, the photoelectric sensors can be turned on based on the real-time received detection distance information. Thus, the control circuit 142 can determine the offset of the echo light spot based on the preset detection distance information corresponding to different emission units, and then turn on the corresponding photoelectric sensor groups 1411, thereby achieving dynamic adjustment of the positions and number of the photoelectric sensor groups 1411, improving the turn-on reliability, and improving the detection accuracy and reliability.

In some embodiments, the control circuit 142 can adjust according to the reception parameter of the last emitted echo. In some embodiments, the control circuit 142 first analyzes the response parameter corresponding to the last echo event. The response parameter includes but is not limited to light intensity, signal-to-noise ratio (SNR), and saturation of the reception device. The light intensity can be measured by analyzing the light intensity of the reflected light pulse, the distance and size of the target can be evaluated, the quality of the received signal can be determined by calculating the signal-to-noise ratio, and whether the reception device is in an oversaturated state can be checked by analyzing the saturation of the reception device, that is, whether the light intensity is too high to cause data distortion.

After analyzing the response parameter, the control circuit 142 determines whether the number of turned-on reception devices needs to be adjusted based on the response parameter, and adjusts the number of turned-on reception devices based on the determination result.

That is, the control circuit 142 can determine whether the number of reception devices (that is, the photoelectric sensor group 1411) needs to be adjusted based on the information obtained from the response parameter. For example, when the light intensity is too high, the control circuit 142 can correspondingly reduce the number of turned-on photoelectric sensor groups 1411, that is, the number of turned-on reception devices is reduced through the conductive part of the common anode and the cathode, so as to avoid data loss caused by the oversaturated state and the crosstalk problem between multiple channels. When the signal-to-noise ratio is low, the control circuit 142 can correspondingly increase (that is, turn on) the number of photoelectric sensor groups 1411 to improve the signal-to-noise ratio. That is, the number of turned-on reception devices is increased through the conductive part of the common anode and the cathode, so as to improve the signal-to-noise ratio of the data and improve the accuracy of the detection data. When the received signal is weak, the control circuit 142 can correspondingly increase the number of photoelectric sensor groups 1411 to improve the sensitivity. In this way, the control circuit 142 can adjust the number of turned-on photoelectric sensor groups 1411 based on the response parameter of the reception device to meet different conduction requirements and improve the adaptability of the photoelectric sensor system 14.

After the photoelectric sensor adjusts the number of turned-on receiving devices based on the judgment result, it needs to be tested to verify the adjustment effect. At this time, the response parameters of the echo are re-measured to ensure that the adjustment achieves the expected improvement effect. According to the test result, further adjustment may be needed. This process can be iterative, and the settings need to be constantly optimized to adapt to different environmental conditions and target characteristics, that is, iterative optimization.

In this way, by adopting the dynamic adjustment of the position and number of the photoelectric sensor group 1411 according to the receiving parameters of the last emitted echo, the adaptability and performance of the photoelectric sensor system 14 can be significantly improved, thereby improving the detection accuracy and reliability, especially in those scenes with rapidly changing environmental conditions and target characteristics. This dynamic adjustment method ensures that the receiving device can maintain optimal performance in different scenarios, thereby improving the overall accuracy and reliability of the photoelectric sensor system 14.

As shown in FIG. 5, the photoelectric sensor group 1411 can include only one photoelectric sensor 1411a, and each photoelectric sensor 1411a in the planar array photoelectric sensor 141 corresponds to a respective laser light source 131. Each photoelectric sensor 1411a is an independent individual, so that the control circuit 142 can selectively turn on and read the echo signal from the single photoelectric sensor 1411a.

Since the echo spot is usually a large circular spot, and the photoelectric sensor 1411a is small in size and limited by the emission angle characteristics of the emission spot of the transmitting module 13, in order to avoid the problem that the echo spot is offset, a single photoelectric sensor 1411a may be unable to completely receive the echo spot, and part of the characteristics of the echo spot may be lost, affecting the light receiving integrity. In some embodiments, as shown in FIG. 6, the photoelectric sensor group 1411 can include three photoelectric sensors 1411a. When multiple photoelectric sensor groups 1411 in each row are connected in common anode, the three photoelectric sensors 1411a are arranged in parallel in sequence, and when the multiple photoelectric sensor groups 1411 in each column are connected in common anode, the three photoelectric sensors 1411a are arranged in parallel in sequence. In this case, each of the three photoelectric sensors 1411a in the planar array photoelectric sensor 141 corresponds to one respective laser light source 131, and the control circuit 142 selectively turns on and reads the echo signal from the photoelectric sensor group 1411 composed of the three photoelectric sensors 1411a. This configuration avoids the problem that a single photoelectric sensor 1411a cannot fully receive the echo spot, which would otherwise result in loss of part of the characteristics of the echo spot and reduce light receiving integrity. By configuring three photoelectric sensors 1411a as one photoelectric sensor to correspond to receive one echo spot, the light receiving integrity of the planar array photoelectric sensor 141 and the detection accuracy are ensured.

It can be understood that the number of the photoelectric sensors 1411a included in the photoelectric sensor group 1411 can also be two or four, and the number of the photoelectric sensors 1411a included in the photoelectric sensor group 1411 is related to the distance between the transmitting device and the receiving device and the divergence angle of the transmitted light spot.

In this example, when the multiple photoelectric sensor groups 1411 in each row are connected in common anode, the three photoelectric sensors 1411a are arranged in sequence in parallel. The laser light sources 131 in the transmitting module 13 start parallel single-point emission along the horizontal direction X. As the single-point light source moves, the photoelectric sensor group 1411 formed by the three photoelectric sensors 1411a in the planar array photoelectric sensor 141 also synchronously receives the sliding window in the horizontal direction X. When the single-point light source moves to the last laser light source 131 in each row, the transmitting module 13 switches to the next row to continue the parallel single-point emission. As the single-point light source moves and changes row, the photoelectric sensor group 1411 formed by the three photoelectric sensors 1411a in the planar array photoelectric sensor 141 also changes the row and synchronously receives the sliding window in the horizontal direction X to the last column of the row, and repeats this scanning process through the last row. Details are not described herein. That is, the control circuit 142 in the present application performs line-by-line scanning on the planar array photoelectric sensor group 141, and after the synchronous sliding window reception in the horizontal direction X reaches the last one in each row, the control circuit 142 switches to the next row to continue, and reads only the echo signal in the light spot region of each row. In this way, in scenarios where the high-reflection features and low-reflection features coexist, the present application can distinguish the effectiveness of the echo signals and read only the effective echo signal, which reduces the problem of an entire row being affected by crosstalk from high-reflection features, thereby minimizing misjudgment by LiDAR 1, improving the recognition capability of LiDAR 1 for both high-reflection and low-reflection features, and ensuring detection accuracy.

It should be noted that in the planar array photoelectric sensor 141, the cathodes of the plurality of photoelectric sensor groups 1411 in each row or each column can be connected together. The first end of the control circuit 142 is connected to the cathodes of the plurality of photoelectric sensor groups 1411 in each row or each column, and the second end of the control circuit 142 is connected to the anode of each photoelectric sensor group 1411. The specific connection manner can be set according to actual requirements, and the present application does not impose any specific limitation in this regard.

The photoelectric sensor system 14 provided by the present application is exemplified below by taking the connection of the common anodes of the plurality of photoelectric sensor groups 1411 in each row or each column as an example.

In order to selectively turn on the common anode of the photoelectric sensor group 1411 in a certain row, in an example, as shown in FIG. 7, the control circuit 142 provided by embodiments of the present application can include a logic unit 1421 and a first switch unit 1422. The first switch unit 1422 includes a plurality of first switches K1, the plurality of first switches K1 are respectively connected to the common anodes of the plurality of photoelectric sensor groups 1411 in one-to-one correspondence, and the controlled ends of the plurality of first switches K1 are all connected to the logic unit 1421. The logic unit 1421 is configured to control the on-off states of the plurality of first switches K1, so as to control the common anodes of the plurality of photoelectric sensor groups 1411, thereby selectively turning on the common anode of the photoelectric sensor group 1411 in a certain row where the echo light spot is located.

For example, assuming that the common anodes of the plurality of photoelectric sensor groups 1411 in the first row need to be turned on, the logic unit 1421 can turn on the first switch K1 connected to the common anode of the photoelectric sensor group 1411 in the first row, and control the first switches K1 corresponding to other rows to be turned off.

In this example, as shown in FIG. 7, the control circuit 142 in embodiments of the present application are further provided with a voltage conversion unit 1423, which is used to provide a power supply voltage VDD to the first switch unit 1422. In some embodiments, the voltage conversion unit 1423 can be a Buck-Boost converter.

In order to selectively turn on the cathodes of the photoelectric sensor groups 1411 in a certain row, in an example, as shown in FIG. 8, the control circuit 142 can further include an amplifying unit 1424 and a second switching unit 1425. The amplifying unit 1424 includes a plurality of amplifiers AMP. First ends (i.e., first input ends) of the plurality of amplifiers AMP are respectively connected to the cathodes of the plurality of photoelectric sensors 1411. The amplifiers AMP are configured to amplify the weak echo signals received by the photoelectric sensor groups 1411. The second switching unit 1425 includes a plurality of second switches K2. One ends of the plurality of second switches K2 are respectively connected to second ends (i.e., output ends) of the plurality of amplifiers AMP. Controlled ends of the plurality of second switches K2 are connected to the logic unit 1421. In this example, the logic unit 1421 is further configured to control the on-off states of the plurality of second switches K2, so as to control the amplifiers AMP, thereby controlling the cathodes of the plurality of photoelectric sensors 1411 in a certain row, and selectively turning on the cathodes of the photoelectric sensors 1411 in the row where the echo spot is located.

For example, assuming that the cathodes of the photoelectric sensor groups 1411 corresponding to the first column, the second column, and the fifth column in the first row need to be turned on, the logic unit 1421 can turn on the second switches K2 connected to the first column, the second column, and the fifth column in the first row, so as to obtain the amplified echo signals, and control the second switches K2 corresponding to the remaining columns in the first row to be turned off.

In this example, as shown in FIG. 8, the amplifying unit 1424 in embodiments of the present application further includes a first resistor R1, a second resistor R2, a first capacitor C1, and a second capacitor C2. A first plate of the first capacitor C1 is connected to the cathodes of the photoelectric sensor groups 1411 and one end of the first resistor R1. The other end of the first resistor R1 is grounded. A second plate of the first capacitor C1 is connected to the first input end of the amplifier AMP. The second input end of the amplifier AMP is grounded. A first plate of the second capacitor C2 and one end of the second resistor R2 are connected to the first input end of the amplifier AMP. A second plate of the second capacitor C2 and the other end of the second resistor R2 are connected to the second input end of the amplifier AMP. It should be understood that the first resistor R1, the second resistor R2, the first capacitor C1, and the second capacitor C2 can be respectively arranged in each amplifying unit 1424, or can be arranged as needed. The present application does not impose any specific limitations in this regard.

In an example, as shown in FIG. 9, the control circuit 142 further includes an analog switch unit 1426. One end of the analog switch unit 1426 is connected with the third ends of the plurality of amplifiers AMP (i.e., the amplifying unit 1424), and the amplified echo signal is obtained when the logic unit 1421 turns on part of the second switches K2. That is, after the control circuit 142 selectively turns on part of the photoelectric sensor groups 1411, the analog switch unit 1426 can realize the function of gating and reading the echo signal from the photoelectric sensor group 1411 in the light spot area.

In an example, as shown in FIG. 9, the control circuit 142 further includes a comparison unit 1427. One end of the comparison unit 1427 is connected with the other end of the analog switch unit 1426, and the echo signal is converted into a digital signal LVDS. In this example, the control circuit 142 further includes a threshold unit 1428. One end of the threshold unit 1428 is connected with the logic unit 1421, and the threshold unit 1428 is configured to provide a threshold voltage for the comparison unit 1427.

In an example, as shown in FIG. 10, the comparison unit 1427 can include a plurality of comparators COMP and a plurality of third capacitors C3. The first plates of the plurality of third capacitors C3 are respectively and correspondingly connected with the other ends of the plurality of second switches K2. The second plates of the plurality of third capacitors C3 are respectively and correspondingly connected with the first input ends of the plurality of comparators COMP. The second input ends of the comparators COMP are connected with the threshold unit 1428. The comparators COMP are configured to access the threshold voltage and compare the voltage at the first input end with the threshold voltage to output a corresponding comparison result. For example, after the analog switch unit 1426 obtains the amplified echo signal and outputs the echo signal to the first input end of the comparator COMP, the voltage of the first input end of the comparator COMP changes, and the output of the comparator COMP also changes correspondingly.

In some embodiments, the threshold unit 1428 can be a DAC threshold unit.

In an example, as shown in FIG. 10, the photoelectric sensor system 14 further includes a digital processing circuit 143. The digital processing circuit 143 is connected with the other end of the comparison unit 1427 and is configured to obtain corresponding distance information according to the digital signal LVDS, thereby completing the ranging function of LiDAR1.

In some embodiments, the digital processing circuit 143 can be a Field Programmable Gate Array (FPGA).

In conclusion, the control circuit 142 can selectively read the echo signal received by the planar array photoelectric sensor 141, and correspondingly amplify and process the echo signal to obtain corresponding distance information, thereby completing the ranging function of LiDAR1. Meanwhile, the control circuit 142 filters and reads only the effective echo signal in the planar array photoelectric sensor 141, without the need to read invalid echo signals from non-spot regions, thereby reducing the processing burden of the control circuit 142, avoiding overloading that could affect system performance, thus ensuring the working stability of the photoelectric sensor system 14, and lowering the design cost.

Based on the photoelectric sensor system 14 provided in the present application, embodiments of the present application further provide a receiving chip, the receiving chip including the photoelectric sensor system 14 described in the above embodiments. The beneficial effects achieved by the receiving chip include the beneficial effects achieved by the photoelectric sensor system 14, and details are not repeated herein.

Based on the photoelectric sensor system 14 provided in the present application, embodiments of the application further provide a LiDAR1. LiDAR1 includes a transmitting module and the photoelectric sensor system 14 in the above embodiments. The transmitting module includes a plurality of array-arranged laser light sources, the laser light sources is used for emitting laser light, and the photoelectric sensor system 14 is used for receiving the echo signal corresponding to the laser light and acquiring corresponding distance information.

The embodiments of the present application further provide a movable device. The movable device includes LiDAR1 in the above embodiments and a movable body, LiDAR1 being mounted on the body. The beneficial effects achieved by the movable device include the beneficial effects achieved by the LiDAR, and details are not repeated herein.

A person skilled in the art can understand that, from the above description of the embodiments, for convenience and brevity of description, only the division of the functional modules is exemplified above. In actual application, the above functions can be implemented by different functional modules as needed. That is, the internal structure of the apparatus may be divided into different functional modules to perform all or part of the functions described above.

In the embodiments of the present application, it should be understood that the disclosed apparatus can be implemented in other manners. For example, the apparatus embodiments described above are merely schematic. For example, the division of the modules or units is merely a logical function division, and other forms of division may be used in actual implementation. For example, a plurality of units or components can be combined or integrated into another apparatus, or some features can be ignored or not performed. In addition, the displayed or discussed coupling or direct coupling or communication connection can be indirect coupling or communication connection through some interfaces, apparatuses or units, and can be electrical, mechanical, or in other forms.

The above content includes only exemplary embodiments of the present application, and the protection scope of the present application is not limited thereto. Any person skilled in the art may readily conceive of changes or replacements within the technical scope disclosed by the present application, and such changes or replacements should fall within the protection scope of the present application. Therefore, the protection scope of the present application shall be defined by the claims.

What is claimed is:

1. A photoelectric sensor system, applied to a LiDAR, the photoelectric sensor system comprising:
a planar array photoelectric sensor including at least two array-arranged photoelectric sensor groups, and a plurality of photoelectric sensor groups in each row or each column are connected with common anodes; and
a control circuit, a first end of the control circuit being connected with the common anodes of the plurality of photoelectric sensor groups in each row or each column, and a second end of the control circuit being connected with cathodes of the plurality of photoelectric sensor groups, the control circuit being configured to turn on the common anodes and the cathodes of a portion of the plurality of photoelectric sensor groups to obtain digital signals corresponding to a portion of echo signals.

2. The photoelectric sensor system according to claim 1, wherein each photoelectric sensor group comprises at least one photoelectric sensor.

3. The photoelectric sensor system according to claim 1, wherein each photoelectric sensor group comprises three photoelectric sensors, and the three photoelectric sensors are arranged in parallel sequentially.

4. The photoelectric sensor system according to claim 2, wherein the control circuit comprises:
a logic unit; and
a first switch unit including a plurality of first switches, wherein the plurality of first switches are respectively connected with the common anodes of the plurality of photoelectric sensor groups in one-to-one correspondence, and controlled ends of the plurality of first switches are all connected with the logic unit,
wherein the logic unit is configured to control on-off states of the plurality of first switches to control the common anodes of the plurality of photoelectric sensor groups.

5. The photoelectric sensor system according to claim 4, wherein the control circuit further comprises:
an amplification unit including a plurality of amplifiers, wherein first ends of the plurality of amplifiers are respectively connected with the cathodes of the plurality of photoelectric sensor groups, and the amplification unit is configured to amplify the echo signals received by the photoelectric sensor groups; and
a second switch unit including a plurality of second switches, wherein one ends of the plurality of second switches are respectively connected with second ends of the plurality of amplifiers, and controlled ends of the plurality of second switches are all connected with the logic unit,
wherein the logic unit is further configured to control the on-off states of the plurality of second switches to control the amplifiers.

6. The photoelectric sensor system according to claim 5, wherein the control circuit further comprises:
an analog switch unit, one end of the analog switch unit being connected with third ends of the plurality of amplifiers, and the analog switch unit being configured to obtain the amplified echo signals when part of the second switches are turned on by the logic unit.

7. The photoelectric sensor system according to claim 6, wherein the control circuit further comprises:
a comparison unit, one end of the comparison unit being connected with the other end of the analog switch unit, and used for converting the echo signal into the digital signal.

8. The photoelectric sensor system according to claim 7, further including:
a digital processing circuit, connected with the other end of the comparison unit and configured to acquire corresponding distance information according to the digital signal.

9. A receiving chip, comprising a photoelectric sensor system, wherein the photoelectric sensor system comprises:
a planar array photoelectric sensor including at least two photoelectric sensor groups arranged in an array, and a plurality of photoelectric sensor groups in each row or each column are connected with common anodes; and
a control circuit, a first end of the control circuit being connected with the common anodes of the plurality of photoelectric sensor groups in each row or each column, and a second end of the control circuit being connected with cathodes of the plurality of photoelectric sensor groups, the control circuit being configured to turn on the common anodes and the cathodes of a portion of the plurality of photoelectric sensor groups to obtain digital signals corresponding to a portion of echo signals.

10. A LIDAR, comprising a transmitting module and a photoelectric sensor system, wherein:
the transmitting module comprises a plurality of array-arranged laser light sources and is configured to emit laser light; and
the photoelectric sensor system is configured to receive an echo signal corresponding to the laser light and acquiring corresponding distance information, wherein the photoelectric sensor system comprises:
a planar array photoelectric sensor including at least two photoelectric sensor groups arranged in an array, and a plurality of photoelectric sensor groups in each row or each column are connected with common anodes; and
a control circuit, a first end of the control circuit being connected with the common anodes of the plurality of photoelectric sensor groups in each row or each column, and a second end of the control circuit being connected with cathodes of the plurality of photoelectric sensor groups, the control circuit being configured to turn on the common anodes and the cathodes of a portion of the plurality of photoelectric sensor groups to obtain digital signals corresponding to a portion of echo signals.
